(19) United States
(12) Patent Application Publication
(10) Pub. No.: US 2008/0076937 A1
(43) Pub. Date: Mar. 27, 2008

(54) Tetradentate Ferrocene Ligands And Their Use

(76) Inventors: Benoit Pugin, Munchenstein (CH); Xaing Dong Feng, Qingdao (CN); Marc Thommen, Nuglar (CH)

Correspondence Address: WENDEROTH, LIND & PONACK, L.L.P., 2033 K STREET N. W., SUITE 800, WASHINGTON, DC, 20006-1021, US

(21) Appl. No.: 11/631,687

(22) PCT Filed: Jul. 4, 2005
(86) PCT No.: PCT/EP05/53170

§ 371 Date: Jan. 5, 2007

(30) Foreign Application Priority Data
Jul. 5, 2004 (CH) 1126/04
Oct. 26, 2004 (CH) 1773/04
Nov. 10, 2004 (CH) 1853/04

(51) Int. Cl. C07F 17/02

(52) U.S. Cl. 556/16

(57) ABSTRACT

Compounds of the formula (I) in the form of racemates, mixtures of diastereomers or pure diastereomers, where R_{O} and Rₒₒ are each, independently of one another, hydrogen, C₁-C₂₀-alkyl, C₃-C₈-cycloalkyl, C₆-C₁₄-aryl or C₃-C₁₂-heteroaryl having heteroatoms selected from the group consisting of O, S and N, which are unsubstituted or substituted by C₁-C₆-alkyl, C₁-C₆-alkoxy, C₅-C₈-cycloalkyl, C₅-C₈-cycloalkoxy, phenyl, C₁-C₆-alkylphenyl, C₁-C₆-alkoxyphenyl, C₃-C₈-heteroaryl, F or trifluoromethyl; the radicals R₁ are each, independently of one another, a hydrogen atom, a halogen atom or a substituent bound to the cyclopentadienyl rings via a C atom, S atom, Si atom, a P(O) or P(S) group; R₂ and R₀₂ are each, independently of one another, a hydrogen atom, C₁-C₂₀-alkyl, C₃-C₈-cycloalkyl, C₆-C₁₄-aryl or C₃-C₁₂-heteroaryl having heteroatoms selected from the group consisting of O, S and N, which are unsubstituted or substituted by C₁-C₆-alkyl, C₁-C₆-alkoxy, C₅-C₈-cycloalkyl, C₅-C₈-cycloalkoxy, phenyl, C₁-C₆-alkylphenyl, C₁-C₆-alkoxyphenyl, C₃-C₈-heteroaryl, F or trifluoromethyl; the two indices m are each, independently of one another, 1, 2 or 3; n is 0 or 1; X₁ is a secondary phosphine group or a cyclic phosphonite group, and X₂ and X₃ are each, independently of one another, a secondary phosphine group. The compounds of the formula (I) are valuable ligands for enantioselective catalysts for the hydrogenation of prochiral, unsaturated compounds.

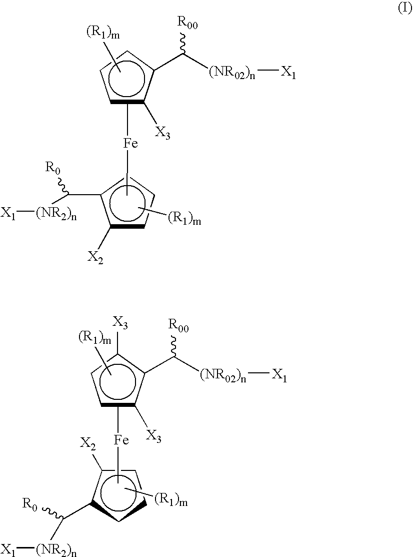

The present invention relates to ferrocenes which are substituted in α positions relative to one another of each of the cyclopentadienyl rings by a secondary phosphine group and a secondary phosphinomethyl group which may be unsubstituted or substituted in the methylene radical, a substituted cyclic phosphonitomethyl group, a substituted secondary phosphinoaminomethyl group or a substituted cyclic phosphonitoaminomethyl group; a process for preparing them; metal complexes with these tetravalent ferrocene ligands; and the use of the metal complexes in enantioselective syntheses.

Chiral ferrocene diphosphines have been found to be valuable ligands in noble metal catalysts for organic syntheses, for example enantioselective addition reactions. Such catalysts have attained particular importance in hydrogenations of double bonds in appropriate prochiral, unsaturated compounds such as substituted olefins, ketones or ketimines. Ferrocene diphosphines of the type described in the U.S. Pat. Nos. 5,463,097, 5,466,844 and 5,583,241 have even been used successfully for some time on an industrial scale for the industrial preparation of optically pure amines from prochiral imines, for example for the hydrogenation of N-(2′,6′-dimethylphenyl)-1-methoxymethylethylideneamine. Ferrocene diphosphines having a phosphine group bound to an N atom are described in WO 02/26750 and are said to be particularly suitable for the hydrogenation of enamides, itaconates and α-keto esters.

Catalysts are auxiliaries, remain as impurities in the reaction product and have to be removed. Efforts are therefore made to use very small amounts, with the molecular weight and the amount of metal being important factors. However, ferrocene diphosphines have not only a high iron content but also a relatively high molecular weight.

It has now been found that the problem of the excessively high iron content and the excessively high molecular weight can be solved without loss of the valuable catalytic properties in the enantioselective hydrogenation of particular aromatic ketimines when the diphosphine structure of the first cyclopentadienyl ring is also present in the second cyclopentadienyl ring so as to form a tetradentate ligand. These ligands are modular and can be prepared easily. They can therefore also be optimized in a simple fashion for specific applications. Metal complexes with these ligands have, despite the many bonding possibilities, valuable catalytic properties which differ from those of the corresponding bidentate ligands and surprisingly can open up new or improved application opportunities. Furthermore, there is also the opportunity of binding two different, catalytically active metals in order to simultaneously hydrogenate, if appropriate stereoselectively, different double bonds such as C═C or C═O and thus avoid the use of two catalysts in two process steps.

The invention firstly provides compounds of the formula I in the form of racemates, mixtures of diastereomers or pure diastereomers, 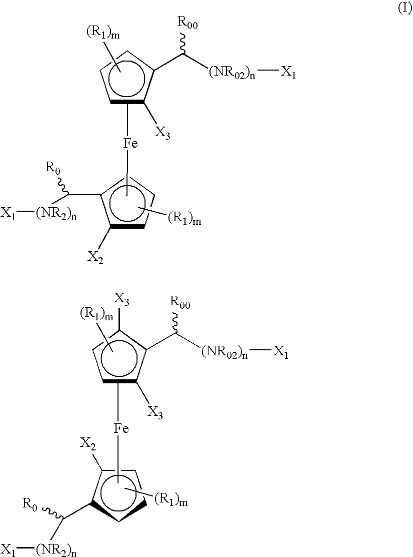
where
R₀ and R₀₀ are each, independently of one another, hydrogen, C₁-C₂₀-alkyl, C₃-C₈-cycloalkyl, C₆-C₁₄-aryl or C₃-C₁₂-heteroaryl having heteroatoms selected from the group consisting of O, S and N, which are unsubstituted or substituted by C₁-C₆-alkyl, C₁-C₆-alkoxy, C₆-C₈-cyclo-alkyl, C₅-C₈-cycloalkoxy, phenyl, C₁-C₆-alkylphenyl, C₁-C₆-alkoxyphenyl, C₃-C₈-heteroaryl, F or trifluoromethyl;
the radicals R₁ are each, independently of one another, a hydrogen atom, a halogen atom or a substituent bound to the cyclopentadienyl rings via a C atom, S atom, Si atom, a P(O) or P(S) group;
R₂ and R₀₂ are each, independently of one another, a hydrogen atom, C₁-C₂₀-alkyl, C₃-C₈-cycloalkyl, C₆-C₁₄-aryl or C₃-C₁₂-heteroaryl having heteroatoms selected from the group consisting of O, S and N, which are unsubstituted or substituted by C₁-C₆-alkyl, C₁-C₆-alkoxy, C₅-C₈-cycloalkyl, C₅-C₈-cycloalkoxy, phenyl, C₁-C₆-alkylphenyl, C₁-C₆-alkoxyphenyl, C₃-C₈-heteroaryl, F or trifluoromethyl;
the two indices m are each, independently of one another, 1, 2 or 3;
n is 0 or 1;
X₁ is a secondary phosphine group or a cyclic phosphonite group, and
X₂ and X₃ are each, independently of one another, a secondary phosphine group.

Substituents R₁ can be present from one to three times or once or twice in each cyclopentadienyl ring.

Hydrocarbon radicals as or in substituents R₁ can in turn bear one or more, for example from one to three, preferably one or two, substituents such as halogen (F, Cl or Br, in particular F), —OH, —SH, —CH(O), —CN, —NR₀₃R₀₄, —C(O)—O—R₀₅, —S(O)—O—R₀₅, —S(O)₂—O—R₀₅, —P(OR₀₅)₂, —P(O)(OR₀₅)₂, —C(O)—NR₀₃R₀₄, —S(O)—NR₀₃R₀₄, —S(O)₂—NR₀₃R₀₄, —O—(O)C—R₀₆, —R₀₃N—(O)C—R₀₆, —R₀₃N—S(O)—R₀₆, —R₀₃N—S(O)₂—R₀₆, C₁-C₄-alkyl, C₁-C₄-alkoxy, C₁-C₄-alkylthio, C₅-C₆-cycloalkyl, phenyl, benzyl, phenoxy or benzyloxy, where R₀₃ and R₀₄ are each, independently of one another, hydrogen, C₁-C₄-alkyl, cyclopentyl, cyclohexyl, phenyl, benzyl or R₀₃ and R₀₄ together form a tetramethylene, pentamethylene or 3-oxapentane-1,5-diyl group, R₀₅ is hydrogen, C₁-C₈-alkyl, C₅-C₆-cycloalkyl, phenyl or benzyl and R₀₆ is C₁-C₁₈-alkyl, preferably C₁-C₁₂-alkyl, C₁-C₄-haloalkyl, C₁-C₄-hydroxyalkyl, C₅-C₈-cycloalkyl (for example cyclopentyl, cyclohexyl), C₆-C₁₀-aryl (for example phenyl or naphthyl) or C₇-C₁₂-aralkyl (for example benzyl).

The substituted or unsubstituted substituent R₁ can be, for example, C₁-C₁₂-alkyl, preferably C₁-C₈-alkyl and particularly preferably C₁-C₄-alkyl. Examples are methyl, ethyl, n- or i-propyl, n-, i- or t-butyl, pentyl, hexyl, heptyl, octyl, decyl and dodecyl.

The substituted or unsubstituted substituent R₁ can be, for example C₅-C₈-cycloalkyl, preferably C₅-C₆-cycloalkyl. Examples are cyclopentyl, cyclohexyl and cyclooctyl.

The substituted or unsubstituted substituent R₁ can be, for example, C₅-C₈-cycloalkyl-alkyl, preferably C₅-C₆-cycloalkyl-alkyl. Examples are cyclopentylmethyl, cyclohexylmethyl or cyclohexylethyl and cyclooctylmethyl.

The substituted or unsubstituted substituent R₁ can be, for example, C₆-C₁₈-aryl, preferably C₆-C₁₀-aryl. Examples are phenyl or naphthyl.

The substituted or unsubstituted substituent R₁ can be, for example, C₇-C₁₂-aralkyl (for example benzyl or 1-phenyleth-2-yl).

The substituted or unsubstituted substituent R₁ can be, for example, tri(C₁-C₄-alkyl)Si or triphenylsilyl. Examples of trialkylsilyl are trimethylsilyl, triethylsilyl, tri-n-propylsilyl, tri-n-butylsilyl and dimethyl-t-butylsilyl.

The substituent R₁ can, for example, be halogen. Examples are F, Cl and Br.

The substituted or unsubstituted substituent R₁ can be, for example, a thio radical or sulphoxide radical or a sulphone radical of the formulae —SR₀₁, —S(O)R₀₁ and —S(O)₂R₀₁, where R₀₁ is C₁-C₁₂-alkyl, preferably C₁-C₈-alkyl and particularly preferably C₁-C₄-alkyl; C₅-C₈-cycloalkyl, preferably C₅-C₆-cycloalkyl; C₆-C₁₈-aryl and preferably C₆-C₁₀-aryl; or C₇-C₁₂-aralkyl. Examples of these hydrocarbon radicals have been mentioned above for R₁.

The substituent R₁ can be, for example, —CH(O), —C(O)—C₁-C₄-alkyl or —C(O)—C₆-C₁₀-aryl.

The substituted or unsubstituted substituent R₁ can be, for example, radicals —CO₂R₀₅ or —C(O)—NR₀₃R₀₄, where R₀₃, R₀₄ and R₀₅ have the abovementioned meanings, including the preferences.

The substituted or unsubstituted substituent R₁ can be, for example, radicals —S(O)—O—R₀₅—S(O)₂—O—R₀₅, —S(O)—NR₀₃R₀₄ and —S(O)₂—NR₀₃R₀₄, where R₀₃, R₀₄ and R₀₅ have the abovementioned meanings, including the preferences.

The substituted or unsubstituted substituent R₁ can be, for example, radicals —P(OR₀₅)₂ or —P(O)(OR₀₅)₂, where R₀₅ has the abovementioned meanings, including the preferences.

The substituted or unsubstituted substituent R₁ can be, for example, radicals —P(O)(R₀₅)₂ or —P(S)(OR₀₅)₂, where R₀₅ has the abovementioned meanings, including the preferences.

An R₁ in the first cyclopentadienyl ring together with an R₁ in the second cyclopentadienyl ring can form a C₂-C₄ chain, preferably a C₂-C₃ chain, for example as 1,2-ethylene, 1,2- and 1,3-propylene.

In a preferred group of the substituents R₁, these are selected from among C₁-C₄-alkyl, substituted or unsubstituted phenyl, tri(C₁-C₄-alkyl)Si, triphenylsilyl, halogen (in particular F, Cl and Br), —SRₐ, —CH₂OH, —CH₂O—Rₐ, —CH(O), —CO₂H, —CO₂Rₐ, where Rₐ is a hydrocarbon radical having from 1 to 10 carbon atoms. R₁ is preferably a hydrogen atom or C₁-C₄-alkyl, preferably methyl.

Examples of substituted or unsubstituted substituents R₁ are methyl, ethyl, n- and i-propyl, n-, i- and t-butyl, pentyl, hexyl, cyclohexyl, cyclohexylmethyl, phenyl, benzyl, trimethylsilyl, F, Cl, Br, methylthio, methylsulphonyl, methylsulphoxyl, phenylthio, phenylsulphonyl, phenyl-sulphoxy, —CH(O), —C(O)OH, —C(O)—OCH₃, —C(O)—OC₂H₅, —C(O)—NH₂, —C(O)—NHCH₃, —C(O)—N(CH₃)₂, —SO₃H, —S(O)—OCH₃, —S(O)—OC₂H₅, —S(O)₂—OCH₃, —S(O)₂—OC₂H₅, —S(O)—NH₂, —S(O)—NHCH₃, —S(O)—N(CH₃)₂, —S(O)—NH₂, —S(O)₂—NHCH₃, —S(O)₂—N(CH₃)₂, —P(OH)₂, PO(OH)₂, —P(OCH₃)₂, —P(OC₂H₅)₂, —PO(OCH₃)₂, —PO(OC₂H₅)₂, trifluoromethyl, methylcyclohexyl, methylcyclohexylmethyl, methylphenyl, dimethylphenyl, methoxyphenyl, dimethoxyphenyl, hydroxymethyl, β-hydroxyethyl, γ-hydroxypropyl, —CH₂NH₂, —CH₂N(CH₃)₂, —CH₂CH₂NH₂, —CH₂CH₂N(CH₃)₂, methoxymethyl, ethoxymethyl, methoxyethyl, ethoxyethyl, HS—CH₂—, HS—CH₂CH₂—, CH₃S—CH₂—, CH₃S—CH₂CH₂—, —CH₂—C(O)OH, —CH₂CH₂—C(O)OH, —CH₂—C(O)OCH₃, —CH₂CH₂—C(O)OCH₃, —CH₂—C(O)NH₂, —CH₂CH₂—C(O)NH₂, —CH₂—C(O)—N(CH₃)₂, —CH₂CH₂—C(O)N(CH₃)₂, —CH₂—SO₃H, —CH₂CH₂—SO₃H, —CH₂—SO₃CH₃, —CH₂CH₂—SO₃CH₃, —CH₂—SO₂NH₂, —CH₂—SO₂N(CH₃)₂, —CH₂—PO₃H₂, —CH₂CH₂—PO₃H₂, —CH₂—PO(OCH₃), —CH₂CH₂—PO(OCH₃)₂, —C₆H₄—C(O)OH, —C₆H₄—C(O)OCH₃, —C₆H₄—S(O)₂OH, —C₆H₄—S(O)₂OCH₃, —CH₂—O—C(O)CH₃, —CH₂CH₂—O—C(O)CH₃, —CH₂—NH—C(O)CH₃, —CH₂CH₂—NH—C(O)CH₃, —CH₂—O—S(O)₂CH₃, —CH₂CH₂—O—S(O)₂CH₃, —CH₂—NH—S(O)₂CH₃, —CH₂CH₂—NH—S(O)₂CH₃, —P(O)(C₁-C₈-alkyl)₂, —P(S)(C₁-C₈-alkyl)₂, —P(O)(C₆-C₁₀-aryl)₂, —P(S)(C₆-C₁₀-aryl)₂, —C(O)—C₁-C₈-alkyl and —C(O)—C₆-C₁₀-aryl.

Alkyl radicals R₀ and R₀₀ can be linear or branched and the alkyl preferably contains from 1 to 12, more preferably from 1 to 8 and particularly preferably from 1 to 6, carbon atoms. Cycloalkyl radicals R₀ and R₀₀ are preferably C₅-C₈-cycloalkyl, particularly preferably C₅-C₆-cycloalkyl. Aryl radicals R₀ and R₀₀ can be, for example, phenyl, naphthyl or anthracenyl, with phenyl being preferred. Heteroaryl radicals R₀ and R₀₀ are preferably C₃-C₈-heteroaryl. Substituents for R₀ and R₀₀ and also R₂ and R₀₂ can be, for example, F, trifluoromethyl, methyl, ethyl, n- or i-propyl, n-, i- or t-butyl, pentyl, hexyl, methoxy, ethoxy, n- or i-propoxy, n-, i- or t-butoxy, pentoxy, hexoxy, cyclopentyl, cyclohexyl, cyclopentoxy, cyclohexoxy, phenyl, methylphenyl, dimethylphenyl, methoxyphenyl, furyl, thienyl or pyrrolyl.

Some examples of R₀ and R₀₀ are methyl, ethyl, n- or i-propyl, n-, i- or t-butyl, pentyl, hexyl, heptyl, octyl, nonyl, decyl, undecyl, dodecyl, cyclopentyl, cyclohexyl, methylcyclohexyl, cyclooctyl, phenyl, benzyl, methylphenyl, methylbenzyl, methoxyphenyl, dimethoxyphenyl, methoxybenzyl, furyl, thienyl, pyrrolyl, imidazolyl, oxazolyl, pyridyl, pyrimidyl, quinolyl, furylmethyl, thienylmethyl and pyrrolylmethyl.

In a preferred embodiment, R₀ and R₀₀ are identical radicals. In another preferred embodiment, R₀ and R₀₀ are identical radicals selected from the group consisting of C₁-C₈-alkyl, C₅-C₈-cycloalkyl, phenyl and benzyl, which are unsubstituted or substituted as defined above.

When R₂ and R₀₂ are alkyl, the alkyl group can be linear or branched and preferably contains from 1 to 12, more preferably from 1 to 8 and particularly preferably from 1 to 6, carbon atoms. When R₂ and R₀₂ are cycloalkyl, cycloalkyl is preferably C₅-C₈-cycloalkyl, particularly preferably C₅-C₆-cycloalkyl. Aryl radicals R₂ and R₀₂ can be, for example, phenyl, naphthyl or anthracenyl, with phenyl being preferred. Heteroaryl radicals R₂ and R₀₂ are preferably C₃-C₈-heteroaryl. Examples of R₂ and R₀₂ and of substituents for R₂ and R₀₂ are the radicals indicated above for R₀ and R₀₀.

In a preferred embodiment, R₂ and R₀₂ are identical radicals. In another preferred embodiment, R₂ and R₀₂ are identical radicals selected from the group consisting of C₁-C₈-alkyl, C₅-C₈-cycloalkyl, phenyl and benzyl, which are unsubstituted or substituted as defined above.

The secondary phosphine groups X₁, X₂ and X₃ and also a phosphonite group X₁ can contain two identical hydrocarbon radicals or two different hydrocarbon radicals. The secondary phosphine groups X₁, X₂ and X₃ and also a phosphonite group X₁ preferably each contain two identical hydrocarbon radicals. Furthermore, the secondary phosphine groups X₁ and X₂, X₁ and X₃, X₂ and X₃ and also X₁, X₂ and X₃ can be identical or different.

The hydrocarbon radicals can be unsubstituted or substituted and/or contain heteroatoms selected from the group consisting of O, S and N. They can contain from 1 to 22, preferably from 1 to 18 and particularly preferably from 1 to 14, carbon atoms. A preferred secondary phosphine is one in which the phosphine group contains two identical or different radicals selected from the group consisting of linear or branched C₁-C₁₂-alkyl; unsubstituted or C₁-C₆-alkyl- or C₁-C₆-alkoxy-substituted C₅-C₁₂-cycloalkyl or C₅-C₁₂-cycloalkyl-CH₂—; phenyl, naphthyl, furyl or benzyl; and phenyl or benzyl substituted by halogen (for example F, Cl and Br), C₁-C₆-alkyl, C₁-C₆-haloalkyl (for example trifluoromethyl), C₁-C₆-alkoxy, C₁-C₆-haloalkoxy (for example trifluoromethoxy), (C₆H₅)₃Si, (C₁-C₁₂-alkyl)₃Si, secondary amino or —CO₂—C₁-C₆-alkyl (for example —CO₂CH₃).

Examples of alkyl substituents on P, which preferably contain from 1 to 6 carbon atoms, are methyl, ethyl, n-propyl, i-propyl, n-butyl, i-butyl, t-butyl, and the isomers of pentyl and hexyl. Examples of unsubstituted or alkyl-substituted cycloalkyl substituents on P are cyclopentyl, cyclohexyl, methylcyclopentyl and ethylcyclopentyl, dimethylcyclopentyl, methylcyclohexyl and ethylcyclohexyl and dimethylcyclohexyl. Examples of alkyl-, alkoxy-, haloalkyl-, haloalkoxy- and halogen-substituted phenyl and benzyl substituents on P are o-, m- or p-fluorophenyl, o-, m- or p-chlorophenyl, difluorophenyl or dichlorophenyl, pentafluorophenyl, methylphenyl, dimethylphenyl, trimethylphenyl, ethylphenyl, methylbenzyl, methoxyphenyl, dimethoxyphenyl, trifluoromethylphenyl, bistrifluoromethylphenyl, tristrifluoromethylphenyl, trifluoromethoxyphenyl, bistrifluoromethoxyphenyl, and 3,5-dimethyl-4-methoxyphenyl.

Preferred secondary phosphine groups are ones which contain identical radicals selected from the group consisting of C₁-C₆-alkyl, unsubstituted cyclopentyl or cyclohexyl, cyclopentyl or cyclohexyl substituted by from 1 to 3 C₁-C₄-alkyl or C₁-C₄-alkoxy radicals, benzyl and in particular phenyl which are unsubstituted or substituted by from 1 to 3 C₁-C₄-alkyl, C₁-C₄-alkoxy, F, Cl, C₁-C₄-fluoroalkyl or C₁-C₄-fluoroalkoxy radicals.

The secondary phosphino group preferably corresponds to the formula —PR₃R₄, where R₃ and R₄ are each, independently of one another, a hydrocarbon radical having from 1 to 18 carbon atoms which is unsubstituted or substituted by halogen, C₁-C₆-alkyl, C₁-C₆-haloalkyl, C₁-C₆-alkoxy, C₁-C₆-haloalkoxy, (C₁-C₄-alkyl)₂-amino, (C₆H₆)₃Si, (C₁-C₁₂-alkyl)₃Si or —CO₂—C₁-C₆-alkyl and/or contains heteroatoms O.

R₃ and R₄ are preferably identical radicals selected from the group consisting of linear or branched C₁-C₆-alkyl, unsubstituted cyclopentyl or cyclohexyl, cyclopentyl or cyclohexyl substituted by from one to three C₁-C₄-alkyl or C₁-C₄-alkoxy radicals, furyl, norbornyl, adamantyl, unsubstituted benzyl or benzyl substituted by from one to three C₁-C₄-alkyl or C₁-C₄-alkoxy radicals, and in particular unsubstituted phenyl or phenyl substituted by from one to three C₁-C₄-alkyl, C₁-C₄-alkoxy, —NH₂, —N(C₁-C₆-alkyl)₂, OH, F, Cl, C₁-C₄-fluoroalkyl or C₁-C₄-fluoroalkoxy radicals.

R₃ and R₄ are particularly preferably identical radicals selected from the group consisting of C₁-C₆-alkyl, cyclopentyl, cyclohexyl, furyl and unsubstituted phenyl or phenyl substituted by from one to three C₁-C₄-alkyl, C₁-C₄-alkoxy and/or C₁-C₄-fluoroalkyl radicals.

The secondary phosphine groups X₁, X₂ and X₃ can be cyclic secondary phosphino, for example groups of the formulae 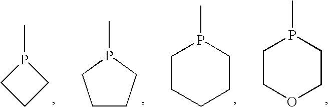
which are unsubstituted or substituted by one or more —H, C₁-C₈-alkyl, C₄-C₈-cycloalkyl, C₁-C₆-alkoxy, C₁-C₄-alkoxy-C₁-C₄-alkyl, phenyl, C₁-C₄-alkylphenyl or C₁-C₄-alkoxyphenyl, benzyl, C₁-C₄-alkylbenzyl or C₁-C₄-alkoxybenzyl, benzyloxy, C₁-C₄-alkylbenzyloxy or C₁-C₄-alkoxybenzyloxy or C₁-C₄-alkylidenedioxyl groups.

The substituents can be bound to the P atom in one or both α positions in order to introduce chiral C atoms. The substituents in one or both α positions are preferably C₁-C₄alkyl or benzyl, for example methyl, ethyl, n- or i-propyl, benzyl or —CH₂—O—C₁-C₄-alkyl or —CH₂—O—C₆-C₁₀-aryl.

Substituents in the β,γ positions can be, for example, C₁-C₄-alkyl, C₁-C₄-alkoxy, benzyloxy or —O—CH₂—O—, —O—CH(C₁-C₄-alkyl)-O— and —O—C(C₁-C₄-alkyl)₂-O—. Some examples are methyl, ethyl, methoxy, ethoxy, —O—CH(phenyl)-O—, —O—CH(methyl)-O— and —O—C(methyl)₂-O—.

In the radicals of the above formulae, an aliphatic 5- or 6-membered ring or benzene can be fused onto two adjacent carbon atoms.

Other known and suitable secondary phosphine radicals are cyclic and chiral phospholanes having seven carbon atoms in the ring, for example radicals of the formulae 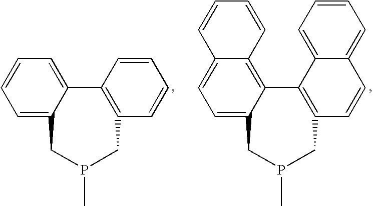
in which the aromatic rings may be substituted by C₁-C₄-alkyl, C₁-C₄-alkoxy, C₁-C₄-alkoxy-C₁-C₂-alkyl, phenyl, benzyl, benzyloxy or C₁-C₄-alkylidenedioxyl or C₁-C₄-alkylenedioxyl (cf. US 2003/0073868 A1 and WO 02/048161).

Depending on the type of substitution and number of substituents, the cyclic phosphine radicals can be C-chiral, P-chiral or C- and P-chiral.

The cyclic secondary phosphino can, for example, correspond to the formulae (only one of the possible diastereomers is indicated), 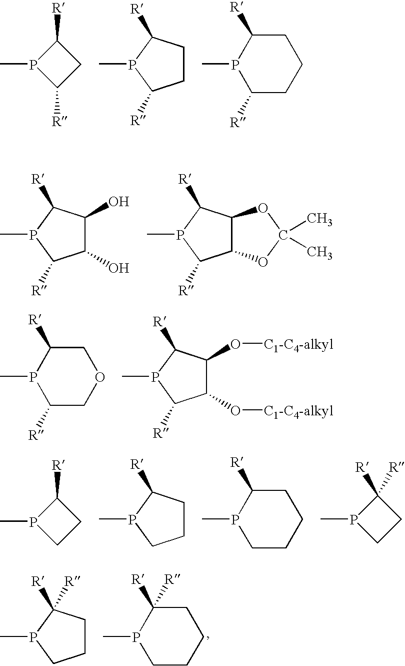
where
the radicals R′ and R″ are each C₁-C₄-alkyl, for example methyl, ethyl, n- or i-propyl, benzyl, or —CH₂—O—C₁-C₄-alkyl or —CH₂—O—C₆-C₁₀-aryl, and R′ and R″ are identical or different. When R′ and R″ are bound to the same carbon atom, they can together form a C₄-C₅-alkylene group.

In a preferred embodiment of the compounds of the formula I, the radicals X₁ are preferably identical and the radicals X₂ and X₃ are identical or different and X₁, X₂ and X₃ are preferably noncyclic secondary phosphine selected from the group consisting of —P(C₁-C₆-alkyl)₂, —P(C₅-C₈-cycloalkyl)₂, —P(C₇-C₁₂-bicycloalkyl)₂, —P(o-furyl)₂, —P(C₆H₅)₂, —P[2-(C₁-C₆-alkyl)-C₆H₄]₂, —P[3-(C₁-C₆-alkyl)C₆H₄]₂, —P[4-(C₁-C₆-alkyl)C₆H₄]₂, —P[2-(C₁-C₆-alkoxy)C₆H₄]₂, —P[3-(C₁-C₆-alkoxy)C₆H₄]₂, —P[4-(C₁-C₆-alkoxy)C₆H₄]₂, —P[2-(trifluoromethyl)C₆H₄]₂, —P[3-(trifluoromethyl)C₆H₄]₂, —P[4-(trifluoromethyl)C₆H₄]₂, —P[3,5-bis(trifluoromethyl)C₆H₃]₂, —P[3,5-bis-(C₁-C₆-alkyl)₂C₆H₃]₂, —P[3,5-bis(C₁-C₆-alkoxy)₂C₆H₃]₂, —P[3,4,5-tris(C₁-C₆-alkoxy)₂C₆H₃]₂, and —P[3,5-bis(C₁-C₆-alkyl)₂-4-(C₁-C₆-alkoxy)C₆H₂]₂, or cyclic phosphine selected from the group consisting of 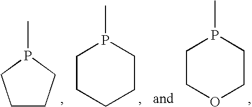
which are unsubstituted or substituted by one or more C₁-C₄-alkyl, C₁-C₄-alkoxy, C₁-C₄-alkoxy-C₁-C₂-alkyl, phenyl, benzyl, benzyloxy, C₁-C₄-alkylidenedioxyl or unsubstituted or phenyl-substituted methylenedioxyl groups.

Some specific examples are —P(CH₃)₂, —P(i-C₃H₇)₂, —P(n-C₄H₉)₂, —P(i-C₄H₉)₂, —P(C₆H₁₁)₂, —P(norbornyl)₂, —P(o-furyl)₂, —P(C₆H₅)₂, —P[2-(methyl)C₆H₄]₂, —P[3-(methyl)C₆H₄]₂, —P[4-(methyl)C₆H₄]₂, —P[2-(methoxy)C₆H₄]₂, —P[3-(methoxy)C₆H₄]₂, —P[4-(methoxy)C₆H₄]₂, —P[3-(trifluoromethyl)C₆H₄]₂, —P[4-(trifluoromethyl)C₆H₄]₂, —P[3,5-bis(trifluoromethyl)C₆H₃]₂, —P[3,5-bis(methyl)₂C₆H₃]₂, —P[3,5-bis(methoxy)₂C₆H₃]₂ and —P[3,5-bis(methyl)₂-4-(methoxy)-C₆H₂]₂, and groups of the formulae 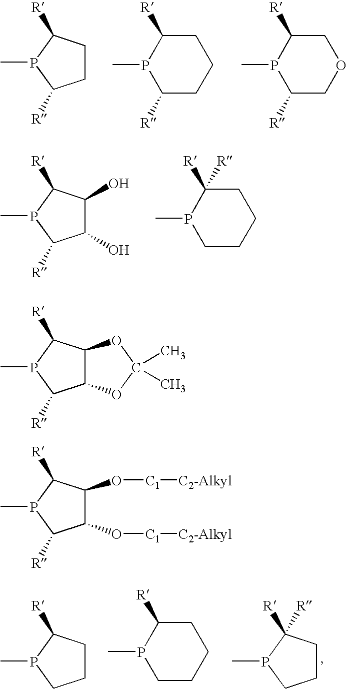
where
R′ is methyl, ethyl, methoxy, ethoxy, phenoxy, benzyloxy, methoxymethyl, ethoxymethyl or benzyloxymethyl and R″ has the same meaning as R′.

The cyclic phosphonite group X₁ can be a five- to eight-membered ring in which the O atoms of the group —O—P—O— are bound to a C₂-C₅ chain in the α,ω positions, with the carbon chain being able to be part of a biaromatic or biheteroaromatic ring. C atoms of the cyclic phosphonite group can be unsubstituted or substituted, for example by the substituents mentioned above for R₁. Preferred substituents are C₁-C₄-alkyl, C₁-C₄-alkoxy, halogens (F, Cl, Br), CF₃ and —C(O)—C₁-C₄-alkyl. When the group —O—P—O— is bound to an aliphatic chain, the latter is preferably substituted or unsubstituted 1,2-ethylene or 1,3-propylene.

The cyclic phosphonite group X₁ can, for example, be formed from a substituted or unsubstituted C₂-C₄-alkylenediol, preferably C₂-diol, and correspond to the formula XIII, 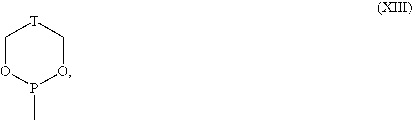
where T is a direct bond or unsubstituted or substituted —CH₂— or —CH₂—CH₂—. Preference is given to T being a direct bond and the phosphonite radical thus having the formula XIIIa, 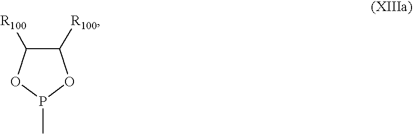
where R₁₀₀ is hydrogen, C₁-C₄-alkyl, phenyl, benzyl, C₁-C₄-alkoxy, methylenedioxyl, alkylidenyidioxyl or C₂-C₄-alkylenedioxyl. Examples of alkylidenyidioxyl are —OC(CH₃)₂O—, —OCH(CH₃)O—, —OCH(C₂H₅)O—, —OCH(n-C₃H₇)O—, —OCH(i-C₃H₇)O—, —OCH(C₆H₅)O— and —OC(C₂H₅)₂O—.

Other cyclic phosphonites can, for example, be derived from 1,1′-biphenyl-2,2′-diols and correspond to the formula XIV, 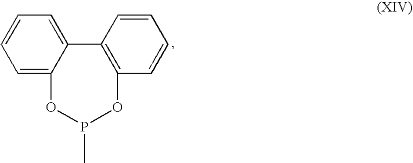
where each phenyl ring is unsubstituted or substituted by from one to five substituents, for example substituents as mentioned for R₁, preferably halogen (F, Cl, Br), CF₃, C₁-C₄-alkyl, C₁-C₄-alkoxy or —C(O)—C₁-C₄-alkyl.

Other cyclic phosphonites can, for example, be derived from 1,1′-binaphthyl-2,2′-diols and correspond to the formula XV, 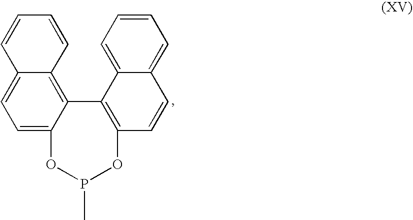
where each naphthyl ring is unsubstituted or substituted by from one to six substituents, for example substituents as mentioned for R₁, preferably halogen (F, Cl, Br), CF₃, C₁-C₄-alkyl, C₁-C₄-alkoxy or —C(O)—C₁-C₄-alkyl.

Other cyclic phosphonites can, for example, be derived from 1,1′-biheteroaromatic-2,2′-diols and correspond to the formula XVI, 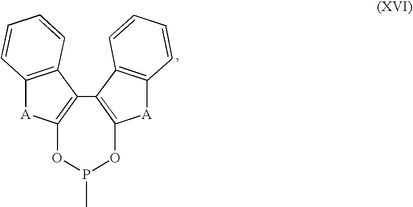
where each phenyl ring is unsubstituted or substituted by from one to four substituents, for example substituents as mentioned for R₁, preferably halogen (F, Cl, Br), CF₃, C₁-C₄-alkyl, C₁-C₄-alkoxy or —C(O)—C₁-C₄-alkyl, and A is —O—, —S—, ═N—, —NH— or —NC₁-C₄-alkyl-.

The compounds of the formula I are preferably present as diastereomers of the formula Ia (R,S,R′,S′ configuration) or Id (S,R,S′,R′ configuration) or mixtures thereof or as diastereomers of the formula Ic (R,R,R′,R′ configuration) or Ib (S,S,S′,S′ configuration) or mixtures thereof,

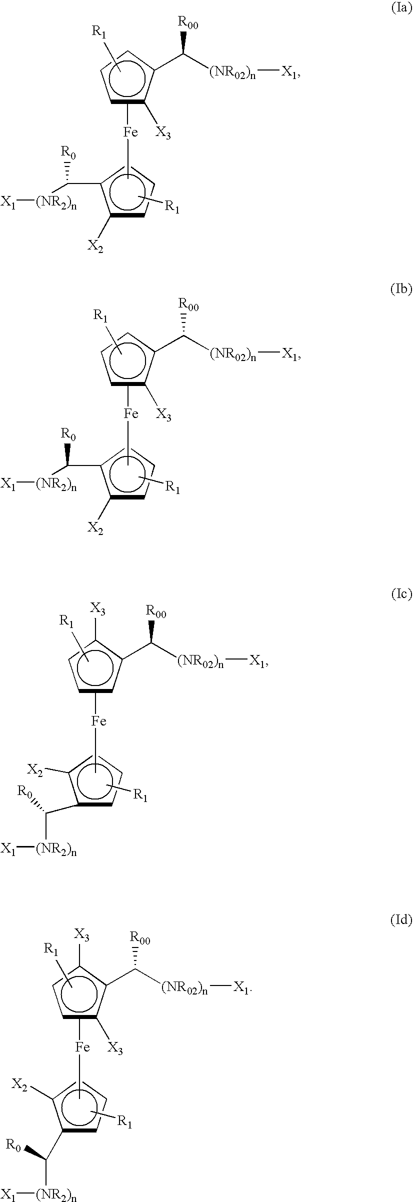

In the case of achiral reactions, any mixtures of conceivable stereoisomers can be used.

The compounds of the formula I and diastereomers or mixtures of diastereomers can be prepared by methods known per se or analogous methods, as are described, for example, in U.S. Pat. No. 5,463,097, by T. Hayashi et al. in J. of Organometallic Chemistry, 370 (1989), pages 129-139 or in WO 96/16971. The preparation of phosphonites is described in U.S. Pat. No. 6,583,305. As an alternative, secondary phosphonites or phosphonite halides can be prepared in a known manner from the diols and then used further, cf. X-P Hu et al., Organic Letters Vol. 6, No. 20, pages 3585 to 3588 (2004).

Ferrocenes having —CHR—O-alkyl or —CHR—NR₂ groups (R is a substituent) in each cyclopentadienyl ring are known. Reaction of these compounds with two equivalents of alkylLi (butylLi, methylLi) and addition of two equivalents of a monohalophosphine enables the secondary phosphine groups X₂ and X₃ to be introduced. The diphosphines obtained have become known as ferriphos when they contain a —CHR—NR₂ group. The two O-alkyl or NR₂ groups are then substituted in a known manner using two equivalents of the secondary phosphine or phosphonite X₁—H. In this process it is possible to block an ortho position in the cyclopentadienyl ring by means of an auxiliary substituent such as trimethylsilyl which can be eliminated, thus enabling diastereomers of the formulae Ic and Id to be prepared in a targeted manner. Compounds of the formula I in which n is 0 are obtained in this way.

To prepare chiral ferrocenes of the formula I in which R₀ and R₀₀ are each hydrogen, ferrocenes in which an N-bonded, chiral amine radical, for example (R) — or (S)—O-methyl-prolinol, is bound to the CH₂ groups are used as starting materials and the above-described process steps are carried out.

Compounds of the formula I in which n is 1 can be prepared by a method analogous to that described in WO 02/26750. Ferrocenes having —CHR—NR₂ groups [for example —CH(CH₃)—NH(CH₃)] in each cyclopentadienyl ring are known. Reaction of these compounds with two equivalents of alkylLi (butylLi, methylLi) and addition of two equivalents of a monochlorophosphine enables the secondary phosphine groups X₂ and X₃ to be introduced. The product is then reacted as described in WO 02/26750 with a carboxylic anhydride, for example acetic anhydride, and then with a primary amine R₂NH₂. In the resulting compounds of the formula II (only one of the possible isomers is given) 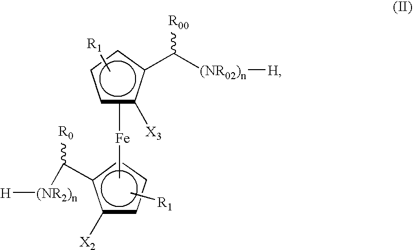
the hydrogen atom on the amine groups can then be replaced by the desired group X₁ by reaction with two equivalents of phosphine halide or phosphonite halide X₁-halogen (halogen is, for example, Cl, Br, I).

In the processes for preparing the ferrocenes, intermediates can be purified, for example, by means of distillation, crystallization or chromatography, before they are used in subsequent steps. The intermediates are obtained in high optical purity in the known processes. The compounds of the formula I are obtained in good yields and purities.

The novel compounds of the formulae I and Ia to If are ligands for forming metal complexes which are excellent catalysts or catalyst precursors for organic syntheses. The metals are preferably selected from among the transition metals. Particular preference is given to the metals Fe, Co, Ni, Cu, Ag, Au, Ru, Rh, Pd, Os, Ir. Very particularly preferred metals are Cu, Pd, Ru, Rh and Ir. Examples of organic syntheses are asymmetric hydrogenations of prochiral, unsaturated, organic compounds, amine couplings, enantioselective ring openings and hydrosilylations. If prochiral unsaturated organic compounds are used, a very high excess of optical isomers can be induced in the synthesis of organic compounds and a high chemical conversion can be achieved in short reaction times. The enantioselectivities and catalyst activities which can be achieved are excellent.

The invention further provides metal complexes of metals selected from the group of transition metals with a compound of the formula I as ligand, with a total of more than 1 and up to 2 equivalents of transition metal being bound. The amount of bound TM-8 metal is preferably from 1.1 to 2 equivalents, particularly preferably from 1.5 to 2 equivalents and very particularly preferably from 1.7 to 2 equivalents.

Possible metals are, for example, Cu, Rh, Pd, Ir, Rᵤ and Pt.

Particularly preferred metals are ruthenium, rhodium and iridium.

Depending on the oxidation number and coordination number of the metal atom, the metal complexes can contain further ligands and/or anions. The complexes can also be cationic metal complexes. Such analogous metal complexes and their preparation are widely described in the literature.

The metal complexes can, for example, correspond to the general formulae III, IV and V,
A₁(Me)₂(Lₙ)₂ (III),
[A₁(Me)₂(Lₙ)₂]^{2(z+)}(E⁻)_{2z} (IV),
[A₁(Me)₂(Lₙ)₂]^{2(z+)}(E²⁻)_{z} (V),
where A₁ is a compound of the formula I,
L represents identical or different monodentate, anionic or nonionic ligands, or L represents identical or different bidentate, anionic or nonionic ligands;
n is 2, 3 or 4 when L is a monodentate ligand, or n is 1 or 2 when L is a bidentate ligand;
z is 1, 2 or 3;
Me is a metal selected from the group consisting of Rh, Ir and Ru, with the metal being in the oxidation state 0, 1, 2 or 3;
E⁻ is the anion or dianion of an oxo acid or a complex acid; and the anionic ligands balance the charge of the oxidation state 1, 2, 3 or 4 of the metal.

With regard to the compounds of the formula I, the above-described preferences and embodiments apply.

Monodentate nonionic ligands can, for example, be selected from the group consisting of olefins (for example ethylene, propylene), solvating solvents (nitriles, linear or cyclic ethers, unalkylated or N-alkylated amides and lactams, amines, phosphines, alcohols, carboxylic esters, sulphonic esters), nitrogen monoxide and carbon monoxide.

Suitable polydendate anionic ligands are, for example, allyls (allyl, 2-methallyl) or deprotonated 1,3-diketo compounds such as acetylacetonate and also cyclopentadienyl.

Monodentate anionic ligands can, for example, be selected from the group consisting of halide (F, Cl, Br, I), pseudohalide (cyanide, cyanate, isocyanate) and anions of carboxylic acids, sulphonic acids and phosphonic acids (carbonate, formate, acetate, propionate, methylsulphonate, trifluoromethylsulphonate, phenylsulphonate, tosylate) and also phenoxide.

Bidentate non-ionic ligands can, for example, be selected from the group consisting of linear or cyclic diolefins (e.g. hexadiene, cyclooctadiene, norbornadiene), dinitriles (malonodinitrile), unalkylated or N-alkylated carboxylic diamides, diamines, diphosphines, diols, dicarboxylic diesters and disulphonic diesters.

Bidentate anionic ligands can, for example, be selected from the group consisting of the anions of dicarboxylic acids, disulphonic acids and diphosphonic acids (e.g. of oxalic acid, malonic acid, succinic acid, maleic acid, methylenedisulphopic acid and methylenediphosphonic acid), dibenzylideneacetone, π-bonded aromatics such as cumene.

Preferred metal complexes also include those in which E is —Cl⁻—, —Br⁻, —I⁻, ClO₄⁻, CF₃SO₃⁻, CH₃SO₃⁻, HSO₄⁻, SO₄²⁻, oxalate, (CF₃SO₂)₂N—, (CF₃SO₂)₃C⁻, tetraarylborates such as B(phenyl)₄⁻, B[bis(3,5-trifluoromethyl)phenyl]₄⁻, B[bis(3,5-dimethyl)phenyl]₄⁻, B(C₆F₅)₄⁻ and B(4-methylphenyl)₄⁻, BF₄⁻, PF₆⁻, SbCl₆⁻, AsF₆⁻ or SbF₆⁻.

Palladium complexes are frequently derived from Pd(0) or Pd(II) and a ligand according to the invention. Examples of suitable Pd precursors for the reaction with the ligands of the invention are Pd(II) salts with inorganic (halides) or organic (carboxylates) anions. A frequently used precursor for Pd(0) is Pd-dibenzylideneacetone.

Particularly preferred metal complexes which are particularly suitable for hydrogenations correspond to the formulae VI, VII and VII,
[ZYMeA₁MeYZ] (VI),
[YMeA₁MeY]²⁺(E₁⁻)₄ (VII),
[YMeA₁MeY]⁴⁺(E₁⁻)₄ (VIII),
where
A₁ is a compound of the formula I;
Me is rhodium or iridium;
Y is two olefins or a diene;
Z is Cl, Br or I; and
E₁⁻ is the anion of an oxo acid or complex acid.

The above-described embodiments and preferences apply to the compounds of the formula I.

Olefins Y can be C₂-C₁₂—, preferably C₂-C₆— and particularly preferably C₂-C₄-olefins. Examples are propene, 1-butene and in particular ethylene. The diene can contain from 5 to 12 carbon atoms, preferably from 5 to 8 carbon atoms, and can be an open-chain, cyclic or polycyclic diene. The two olefin groups of the diene are preferably connected by one or two CH₂ groups. Examples are 1,4-pentadiene, cyclopentadiene, 1,5-hexadiene, 1,4-cyclohexadiene, 1,4- or 1,5-heptadiene, 1,4- or 1,5-cycloheptadiene, 1,4- or 1,5-octadiene, 1,4- or 1,5-cyclooctadiene and norbornadiene. Y is preferably two ethylene molecules or 1,5-hexadiene, 1,5-cyclooctadiene or norbornadiene.

In the formula VI, Z is preferably Cl or Br. Examples of E₁ are BF₄⁻, ClO₄⁻, CF₃SO₃⁻, CH₃SO₃⁻, HSO₄⁻, B(phenyl)₄⁻, B[bis(3,5-trifluoromethyl)phenyl]₄⁻, PF₆⁻, SbCl₆⁻, AsF₆⁻ or SbF₆⁻.

The invention encompasses metal complexes containing two different metals selected from the group of transition metals. In this case, from 0.01 to 1.99 equivalents, preferably from 0.5 to 1 equivalent, of the one metal Me₁ and, correspondingly, from 1.99 to 0.01 equivalents, preferably from 1.5 to 1 equivalents, of the other metal Me₂ can be present. These complexes particularly preferably contain from 0.8 to 1.2 equivalents of the one metal Me₁ and, correspondingly, from 1.2 to 0.8 equivalents of the other metal Me₂. Possible combinations of transition metals are, for example, Rh/Ru, Rh/Ir, Ru/Ir, Ir/Pt, Ir/Pd, Rh/Pt, Rh/Pd, Ru/Pt and Ru/Pd.

The metal complexes can, for example, correspond to the general formulae IX and X,
(Lₙ)(Me₁)ₓA₁(Me₂)_{y}(Lₙ) (IX),
[(Lₙ)(Me₁)ₓA₁(Me₂)_{y}(Lₙ)]^{2(z+)}(E⁻)_{2z} (X),
where
x is from 0.5 to 1.5, y is from 1.5 to 0.5 and x+y is 2,
Me₁ and Me₂ are different transition metals, and
A₁, L and z have the abovementioned meanings, including the preferences.

The transition metals Me₁ and Me₂ are preferably selected from the group consisting of rhodium, iridium ruthenium, platinum and palladium, particularly preferably from the group consisting of ruthenium, rhodium and iridium.

The index x is preferably from 0.8 to 1.2, and the index y is preferably correspondingly a number from 1.2 to 0.8.

The metal complexes having two different transition metals preferably correspond to the formulae XI and XII,
[ZYMe₁A₁Me₂YZ] (XI),
[YMe₁A₁Me₂Y]⁴⁺(E₁⁻)₄ (XII),
where
A₁, L, Me₁, Me₂, Y, Z and E₁ have the abovementioned meanings, including the preferences.

The metal complexes of the invention are prepared by methods known from the literature (see also U.S. Pat. No. 5,371,256, U.S. Pat. No. 5,446,844, U.S. Pat. No. 5,583,241, and E. Jacobsen, A. Pfaltz, H. Yamamoto (Eds.), Comprehensive Asymmetric Catalysis I to III, Springer Verlag, Berlin, 1999, and references cited therein).

The metal complexes of the invention are homogeneous catalysts, or catalyst precursors which can be activated under the reaction conditions, which can be used for asymmetric addition reactions onto prochiral, unsaturated, organic compounds, cf. E. Jacobsen, A. Pfaltz, H. Yamamoto (Eds.), Comprehensive Asymmetric Catalysis I to III, Springer Verlag, Berlin, 1999, and B. Cornils et al., in Applied Homogeneous Catalysis with Organometallic Compounds, Volume 1, Second Edition, Wiley VCH-Verlag (2002). Further applications are, for example, the amination of aromatics or heteroaromatics containing leaving groups such as halide or sulphonate by means of primary or secondary amines using palladium complexes or the preferably Rh catalysed enantioselective ring-opening reaction of oxabicyclic alkanes (M. Lautens et al. In Acc. Chem. Res. Volume 36 (203), pages 48-58.

The metal complexes can, for example, be used for the asymmetric hydrogenation (addition of hydrogen) of prochiral compounds having carbon/carbon or carbon/heteroatom double bonds. Such hydrogenations using soluble homogeneous metal complexes are described, for example, in Pure and Appl. Chem., Vol. 68, No. 1, pp. 131-138 (1996). Preferred unsaturated compounds to be hydrogenated contain the groups C═C, C═N and/or C═O. According to the invention, preference is given to using metal complexes of ruthenium, rhodium and iridium for the hydrogenation.

The invention further provides for the use of the metal complexes of the invention as homogeneous catalysts for the preparation of chiral organic compounds by asymmetric addition of hydrogen onto a carbon-carbon or carbon-heteroatom double bond in prochiral organic compounds.

A further aspect of the invention is a process for preparing chiral organic compounds by asymmetric addition of hydrogen onto a carbon-carbon or carbon-heteroatom double bond in prochiral organic compounds in the presence of a catalyst, which is characterized in that the addition reaction is carried out in the presence of catalytic amounts of at least one metal complex according to the invention.

Preferred prochiral, unsaturated compounds to be hydrogenated can contain one or more, identical or different C═C, C═N and/or C═O groups in open-chain or cyclic organic compounds, with the C═C, C═N and/or C═O groups being able to be part of a ring system or being exocyclic groups. The prochiral unsaturated compounds can be alkenes, cycloalkenes, heterocycloalkenes and also open-chain or cyclic ketones, α,β-diketones, α- or β-ketocarboxylic acids and their α,β-ketoacetals or -ketoketals, esters and amides, ketimines and kethydrazones. Alkenes, cycloalkenes, heterocycloalkenes also include enamides.

The process of the invention can be carried out at low or elevated temperatures, for example temperatures of from −20 to 150° C., preferably from −10 to 100° C. and particularly preferably from 10 to 80° C. The optical yields are generally better at relatively low temperature than at higher temperatures.

The process of the invention can be carried out at atmospheric pressure or superatmospheric pressure. The pressure can be, for example, from 105 to 2×10⁷ Pa (pascal) Hydrogenations can be carried out at atmospheric pressure or superatmospheric pressure.

Catalysts are preferably used in amounts of from 0.00001 to 10 mol %, particularly preferably from 0.00001 to 5 mol % and very particularly preferably from 0.00001 to 2 mol %, based on the compound to be hydrogenated.

The preparation of the ligands and catalysts and the hydrogenation can be carried out in the presence or absence of an inert solvent, with one solvent or mixtures of solvents being able to be used. Suitable solvents are, for example, aliphatic, cycloaliphatic and aromatic hydro-carbons (pentane, hexane, petroleum ether, cyclohexane, methylcyclohexane, benzene, toluene, xylene), aliphatic halogenated hydrocarbons (methylene chloride, chloroform, dichloroethane and tetrachloroethane), nitriles (acetonitrile, propionitrile, benzonitrile), ethers (diethyl ether, dibutyl ether, t-butyl methyl ether, ethylene glycol dimethyl ether, ethylene glycol diethyl ether, diethylene glycol dimethyl ether, tetrahydrofuran, dioxane, diethylene glycol monomethyl or monoethyl ether), ketones (acetone, methyl isobutyl ketone), carboxylic esters and lactones (ethyl or methyl acetate, valerolactone), N-substituted lactams (N-methylpyrrolidone), carboxamides (dimethylamide, dimethylformamide), acyclic ureas (dimethylimidazoline) and sulphoxides and sulphones (dimethyl sulphoxide, dimethyl sulphone, tetramethylene sulphoxide, tetramethylene sulphone) and fluorinated or unfluorinated alcohols (methanol, ethanol, propanol, butanol, ethylene glycol monomethyl ether, ethylene glycol monoethyl ether, diethylene glycol monomethyl ether, 1,1,1-trifluoroethanol) and water. Further suitable solvents are low molecular weight carboxylic acids such as acetic acid. The solvents can be used alone or as mixtures of at least two solvents.

The reaction can be carried out in the presence of cocatalysts, for example quaternary ammonium halides (tetrabutylammonium iodide) and/or in the presence of protic acids, for example mineral acids (cf., for example U.S. Pat. No. 5,371,256, U.S. Pat. No. 5,446,844 and U.S. Pat. No. 5,583,241 and EP-A-0 691 949). The presence of fluorinated alcohols such as 1,1,1-trifluoroethanol can likewise promote the catalytic reaction. In the hydrogenation of prochiral aryl ketimines, the use of iridium complexes in combination with tetra-C₁-C₄-alkylammonium iodides and mineral acids, preferably HI, has been found to be useful.

The metal complexes used as catalysts can be added as separately prepared, isolated compounds, or they can be formed in situ prior to the reaction and then mixed with the substrate to be hydrogenated. It can be advantageous in the case of a reaction using isolated metal complexes to add additional ligands or, in the in situ preparation, to use an excess of ligands. The excess can be, for example, up to 6 mol and preferably up to 2 mol, based on the metal compound used for the preparation.

The process of the invention is generally carried out by placing the catalyst in a reaction vessel and then adding the substrate, if desired reaction auxiliaries, and the compound to be added on, and then starting the reaction. Gaseous compounds to be added on, for example hydrogen, are preferably introduced by pressurising the reactor with them. The process can be carried out continuously or batchwise in various types of reactor.

The chiral organic compounds which can be prepared according to the invention are active substances or intermediates for the preparation of such substances, in particular in the field of production of flavours and fragrances, pharmaceuticals and agrochemicals.

The following examples illustrate the invention.

### A) PREPARATION OF TETRAPHOSPHINOFERROCENES

Abbreviations: Me is methyl, Et is ethyl, Bu is butyl, Ph is phenyl, Xyl is 3,5-dimethylphen-1-yl, Cy is cyclohexyl, Ac is acetyl, MOD is 3,5-dimethyl-4-methoxyphenyl, THF is tetrahydrofuran, TBME is t-butyl methyl ether, MeOH is methanol, EtOH is ethanol, DME is dimethoxyethane, Etpy is ethyl pyruvate.

### EXAMPLE A1

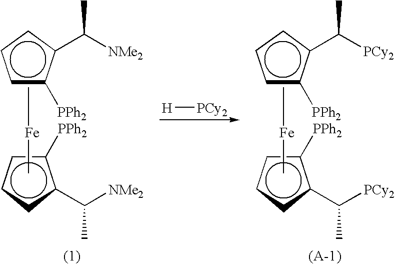

0.34 ml (1.7 mmol) of dicyclohexylphosphine is added to 536 mg (0.77 mmol) of the (R,S)-diamine-diphosphine compound (1) in 5 ml of acetic acid and the red solution is stirred overnight at 105° C. After cooling, the reaction mixture is shaken with toluene and water. After separating off the toluene phase, the aqueous phase is admixed with sodium chloride (about 2.5 g of NaCl per 10 ml of water) and again extracted a number of times with toluene. The organic phases are combined, dried over sodium sulphate and evaporated on a rotary evaporator. The red crude product is purified by chromatography (silica gel Merck 60, eluent:heptane/TBME 50:1). The product (A1) is obtained as a solid crystalline substance. The yield is 424 mg (55% of theory).

¹H-NMR (C₆D₆): δ 0.8-2.0 (m, 50H), 3.11 (s, 2H), 3.56 (m, 2H), 4.40-4.55 (m, 4H), 6.85-7.55 (m, 20H). ³¹P-NMR (C₆D₆): δ+16.3 (d); −25.5 (d).

### EXAMPLE A2

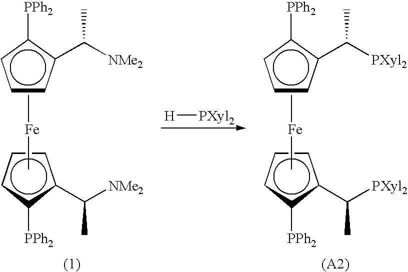

1.7 mmol of di-3,5-xylylphosphine (24.3% strength solution in toluene) are added to 518 mg (0.74 mmol) of the (S,R)-diamine-diphosphine compound (1) in 2.5 ml of acetic acid and the red solution is stirred overnight at 105° C. After cooling, the reaction mixture is shaken with toluene and water. The organic phases are combined, dried over sodium sulphate and evaporated on a rotary evaporator. The red crude product is purified by chromatography (silica gel Merck 60, eluent:heptane/TBME 10:1). The substance (A2) is obtained as a solid material. The yield is 540 mg (67% of theory).

¹H-NMR (C₆D₆): δ 1.78 (t, 6H), 1.99 (s, 12H), 2.06 (s, 12H), 3.16 (s, 2H), 4.10 (m, 2H), 4.44 (s, 2H), 4.57 (m, 2H), 6.60-7.55 (m, 32H). ³¹P-NMR(C₆D₆): δ+8.3 (d), −25.1 (d).

### EXAMPLE A3

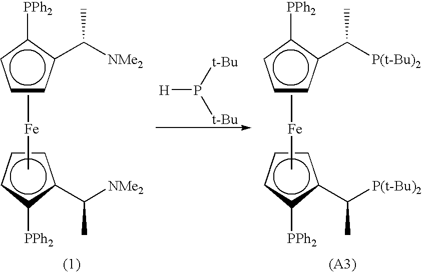

35 g of a 10% solution of di-t-butylphosphine (23.9 mmol) in acetic acid are added to 5.12 g (7.34 mmol) of the (S,R)-diamine-diphosphine compound (1) and the reaction mixture is stirred overnight at 105° C. After cooling, the acetic acid is distilled off under reduced pressure on a rotary evaporator. The solid residue is washed with 2×25 ml of cold ethanol and dried in a high vacuum. The crude product is then dissolved in methylene chloride and extracted with water. The organic phase is dried over sodium sulphate and the solvent is distilled off under reduced pressure on a rotary evaporator. Recrystallization from toluene gives a yellow, solid product having a purity of >90% in a yield of 48%.

¹H-NMR (CDCl₃), characteristic signals: δ 7.36-7.03 (20H), 4.25 (m, 2H), 4.12 (m, 2H), 3.39 (m, 2H), 3.04 (m, 2H), 1.94 (m, 6H), 1.17 (d, 18H), 0.93 (d, 18H). ³¹P-NMR (CDCl₃): δ+51.8 (d); −26.4 (d).

### EXAMPLE A4

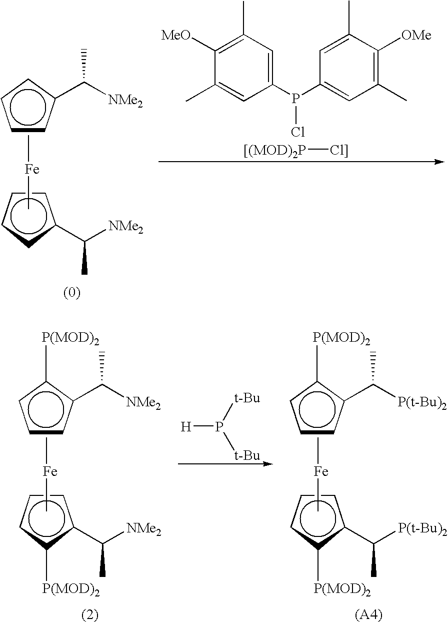 a) Preparation of Compound (2)

30.45 ml (39.6 mmol) of s-BuLi (1.3 molar in cyclohexane) are added dropwise at from 0° C. to 5° C. to a solution of 5.144 g (16.5 mmol) of the compound (0) in 25 ml of diethyl ether over a period of about 30 minutes while stirring and the reaction mixture is stirred for another 3.5 hours at this temperature. 14.44 g (42.9 mmol) of bis(MOD)chlorophosphine are then added, the cooling is removed and the reaction mixture is stirred further overnight. The mixture is slowly admixed with water and extracted with water/TBME, the organic phases are collected, dried over sodium sulphate and the solvent is distilled off under reduced pressure on a rotary evaporator. The crude product is prepurified by chromatography on a column (silica gel 60; eluent:ethanol). Recrystallization from ethanol gives 7.03 g of pure product as a yellow, crystalline material (yield: 46%).

¹H-NMR (C₆D₆), characteristic signals: δ 7.52 (s, 2H), 7.50 (s, 2H), 7.14 (s, 2H), 7.11 (s, 2H), 4.37-4.28 (m, 6H), 3.86 (m, 2H), 3.30 (two s, 12H), 2.1 (s, 12H), 2.09 (s, 12H), 1.90 (s, 12H), 1.40 (d, 6H). ³¹P-NMR (C₆D₆): δ−23.7 (s).

b) Preparation of Compound (A4)

18.9 g of a 10% solution of di-t-butylphosphine (12.02 mmol) in acetic acid are added to 4.0 g (4.31 mmol) of the (S,R)-diamine-diphosphine compound (2) in 20 ml of acetic acid and the reaction mixture is stirred overnight at 105° C. After cooling, the mixture is extracted with methylene chloride/water, the organic phase is dried over sodium sulphate and the solvent is distilled off under reduced pressure on a rotary evaporator. The crude product is purified by chromatography (silica gel 60; eluent=10 heptane/1 TBME/0.1 triethylamine). The product is obtained as an orange, crystalline compound (yield: 50%).

¹H-NMR (C₆D₆), characteristic signals: δ 7.73 (s, 2H), 7.70 (s, 2H), 7.23 (s, 2H), 7.21 (s, 2H), 4.18 (m, 2H), 3.93 (m, 2H), 3.70 (q, 2H), 3.65 (m, 2H), 3.36 (s, 6H), 3.26 (s, 6H), 2.33 (m, 6H), 2.24 (s, 12H), 2.12 (s, 12H), 1.42 (d, 18H), 1.15 (d, 18H). ³¹P-NMR (C₆D₆): δ+52.2 (d), −26.5 (d).

### EXAMPLE A5

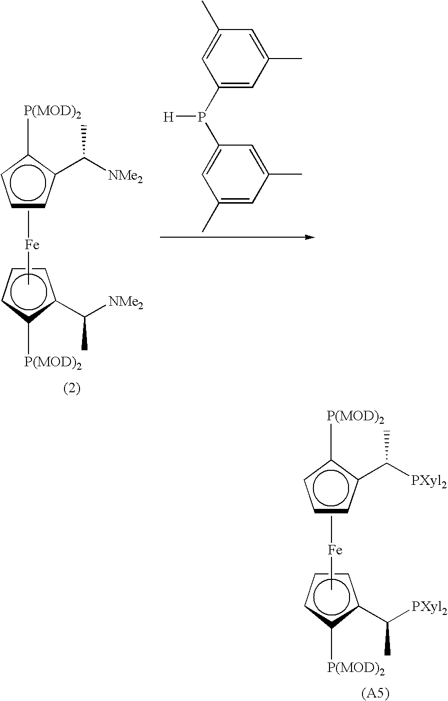

3.81 g of a 24.3% solution of di(3,5-dimethylphenyl)phosphine (3.08 mmol) in acetic acid are added to 1.0 g (1.23 mmol) of the (S,R)-diamine-diphosphine compound (2) in 4 ml of acetic acid and the reaction mixture is stirred at 105° C. for 10 hours. After cooling, the acetic acid is distilled off under reduced pressure on a rotary evaporator and the residue is extracted with water/ethyl acetate. The organic phase is dried over sodium sulphate and the solvent is distilled off under reduced pressure on a rotary evaporator. Purification by chromatography (silica gel 60; eluent=1 ethyl acetate/9 heptane) gives the desired product as an orange solid (yield 81%).

¹H-NMR (C₆D₆), characteristic signals: δ 7.56 (s, 2H), 7.53 (s, 2H), 7.31 (s, 2H), 7.28 (s, 2H), 7.23 (s, 2H), 7.20 (s, 2H), 7.14 (s, 2H), 7.12 (s, 2H), 6.81 (s, 2H), 6.64 (s, 2H), 4.22 (m, 2H), 4.16 (m, 2H), 4.08 (m, 2H), 3.99 (m, 2H), 3.33 (s, 6H), 3.22 (s, 6H), 2.14 (s, 12H), 2.11 (s, 12H), 2.09 (s, 12H), 2.03 (s, 12H), 1.82 (m, 6H). ³¹P-NMR (C₆D₆): δ+10.5 (d), −24.9 (d).

### EXAMPLE A6

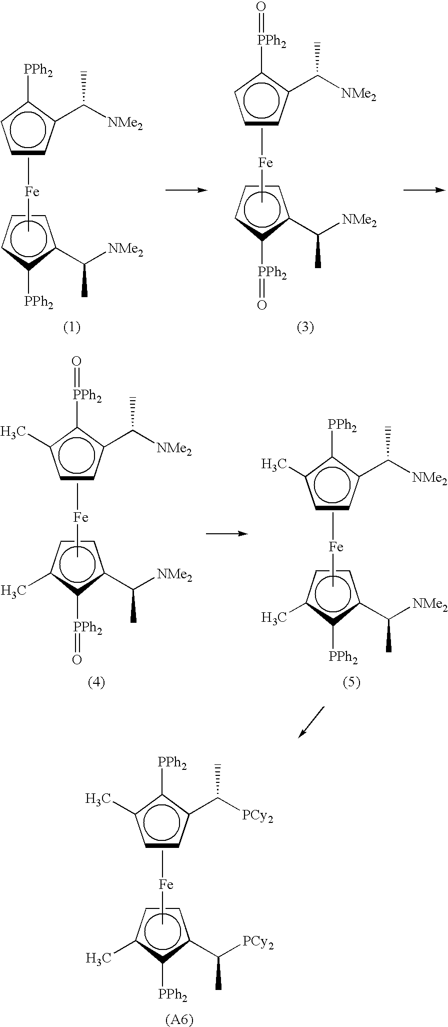 a) Preparation of Compound (3)

2.6 ml (14.4 mmol) of a solution of t-butyl hydroperoxide in nonane (5.5 molar) are added dropwise at 0° C. to a solution of 5 g (7.2 mmol) of the S,R compound (1) in 40 ml of THF while stirring. The cooling is subsequently removed and the mixture is stirred further overnight, with a yellow precipitate being formed. After addition of 40 ml of heptane, the mixture is filtered, the solid is washed with a little cold diethyl ether and dried under reduced pressure (yield: 88%). The crude product is pure and can be used further without further purification.

¹H-NMR (CDCl₃), characteristic signals: δ 7.6-7.4 (m, 20H), 5.01 (m, 2H), 4.40 (m, 2H), 4.27 (m, 2H), 3.32 (m, 2H), 1.56 (s, 12H), 1.19 (d, 6H). ³¹P-NMR (CDCl₃): δ+26.3 (s).

b) Preparation of Compound (4)

10.4 ml (16.8 mmol) of n-BuLi (1.6 molar in hexane) are added dropwise at −78° C. to a solution of 4 g (5.6 mmol) of the compound (3) in 200 ml of THF while stirring. The reaction mixture is stirred for another 2 hours at this temperature. 1.05 ml (16.8 mmol) of methyl iodide are then added dropwise at −78° C. and the reaction mixture is stirred further for 0.5 hours at −78° C., then for 1 hour at −40° C. and finally for 30 minutes at −10° C. before being admixed with 5 ml of water at −10° C. while stirring vigorously. The organic solvent and any unreacted methyl iodide is immediately distilled off under reduced pressure at a maximum of 50° C. and the residue is extracted with methylene chloride/aqueous NaCl solution. The organic phases are collected, dried over sodium sulphate and the solvent is distilled off under reduced pressure on a rotary evaporator. The crude product is obtained as an orange solid which is used further without further purification (yield: >98%).

¹H-NMR (C₆D₆), characteristic signals: δ 7.89-7.7 (m, 8H), 7.1-6.9 (m, 12H), 5.40 (s, 2H), 4.30 (m, 2H), 4.09 (m, 2H), 1.68 (s, 12H), 1.46 (s, 6H), 1.38 (d, 6H). ³¹P-NMR (C₆D₆): δ+27.2 (s).

c) Preparation of Compound (5):

A suspension of 390 mg (0.53 mmol) of the phosphine oxide (4) and 1.9 ml (10.5 mmol) of HSi(OEt)₃ in 10 ml of toluene is heated to reflux while stirring. 0.19 ml (0.64 mmol) of titanium(IV) isopropoxide are then slowly added dropwise over a period of 20 minutes and the reaction mixture is refluxed further overnight. After cooling, the toluene is distilled off on a rotary evaporator, the residue is suspended in 2 ml of ethyl acetate and applied to a column. Chromatography (silica gel 60; eluent=ethyl acetate with 1% of triethylamine) gives the desired product as an orange foam in a yield of 73%.

¹H-NMR (C₆D₆), characteristic signals: δ 7.8-7.7 (m, 4H), 7.4-7.3 (m, 4H), 7.33-7.0 (m, 12H), 4.70 (s, 2H), 4.28 (m, 2H), 3.62 (m, 2H), 1.79 (s, 12H), 1.40 (s, 6H), 1.32 (d, 6H). ³¹P-NMR (C₆D₆): δ−15.3 (s).

d) Preparation of Compound (A6):

A solution of 120 mg (0.17 mmol) of the diphosphine (5) and 81 mg (0.4 mmol) of dicyclohexylphosphine in 0.5 ml of acetic acid is stirred overnight at 105° C. After cooling, the acetic acid is distilled off under reduced pressure on a rotary evaporator, and the residue is then taken up in toluene and washed with water. The organic phase is dried over sodium sulphate and the toluene is evaporated on a rotary evaporator. Purification by chromatography (silica gel 60; eluent=1 ethyl acetate/20 heptane) gives the desired product as a yellow solid (yield: 67%).

¹H-NMR (C₆D₆), characteristic signals: δ 7.92-7.82 (m, 4H), 7.4-7.3 (m, 4H), 7.33-7.0 (m, 12H), 4.38 (s, 2H), 3.72 (m, 2H), 3.69 (m, 2H). ³¹P-NMR (C₆D₆): δ+19.0 (d); −14.4 (d).

### EXAMPLE A7

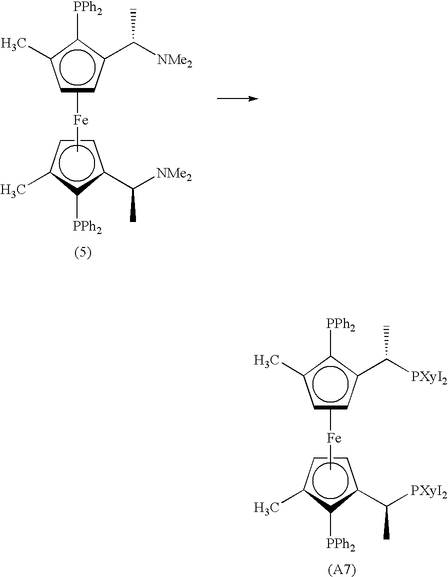

A solution of 200 mg (0.28 mmol) of the diphosphine (5) and 860 mg (0.69 mmol) of di(3,5-dimethylphenyl)phosphine in 1 ml of acetic acid is stirred overnight at 105° C. After cooling, the acetic acid is distilled off under reduced pressure on a rotary evaporator. Purification by chromatography (silica gel 60; eluent=1 ethyl acetate/20 heptane) gives the desired product as an orange foam (yield: 67%).

¹H-NMR (C₆D₆), characteristic signals: δ 7.75-7.65 (m, 4H), 7.65-7.55 (m, 4H), 7.20-6.90 (m, 20H), 6.77 (s, 2H), 6.67 (s, 2H), 4.28 (m, 2H), 4.23 (m, 2H), 3.63 (m, 2H), 2.08 (s, 12H), 2.02 (s, 12H), 1.69 (s, 6H), 1.61 (m, 6H). ³¹ P-NMR (C₆D₆): δ+8.7 (d); −15.8 (d).

### EXAMPLE A8

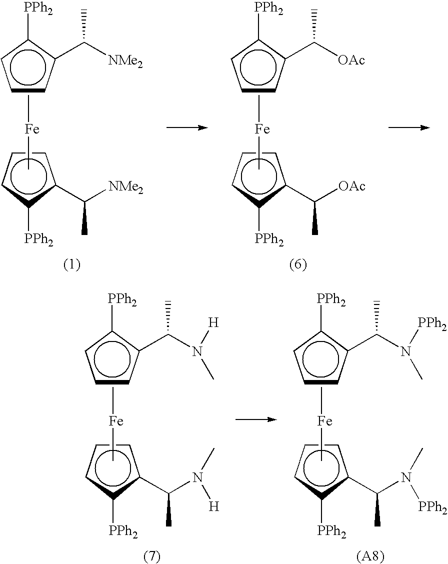 a) Preparation of Compound (6)

The compound (6) is prepared as described by T. Hayashi et al. in J. Organometal. Chem., 370 (1989), pages 129-139.

b) Preparation of Compound (7):

4 ml (33.2 mmol) of a 40% methylamine solution in water are added to 403 mg (0.55 mmol) of the compound (6) in 5 ml of isopropanol and the reaction mixture is stirred in a closed pressure ampoule at 90° C. for 66 hours. After distilling off the volatile components, the residue is taken up in ethyl acetate/heptane 1:1 and extracted with 10% aqueous citric acid. The aqueous phase is washed with ethyl acetate/heptane 1:1. After addition of 2n NaOH until the solution is basic, the crude product is extracted in methylene chloride, the organic phase is dried over sodium sulphate and then evaporated on a rotary evaporator. Chromatography (silica gel 60; eluent=ethanol with 1% of cyclohexane) gives the desired product as a yellow, solid foam (yield: 58%).

¹H-NMR (C₆D₆), characteristic signals: δ 7.43-7.37 (m, 4H), 7.3-7.25 (m, 4H), 6.99-6.86 (m, 12H), 4.55 (s, 2H), 4.39 (m, 2H), 4.10-4.03 (m, 2H), 3.21 (m, 2H), 2.06 (s, 12H), 1.51 (d, 6H). ³¹P-NMR (C₆D₆): δ−24.2 (s).

c) Preparation of Compound (A8)

209 mg (0.313 mmol) of the compound (7), 0.2 ml (1.4 mmol) of triethylamine and 0.15 ml (0.81 mmol) of diphenylphosphine chloride in 2 ml of toluene are stirred overnight at 50° C. After cooling, 10 ml of heptane are added, the triethylammonium chloride which has precipitated is filtered off and the filtrate is evaporated under reduced pressure on a rotary evaporator. Chromatography (silica gel 60; eluent: 80 heptane/20 ethyl acetate/2.5 triethylamine) gives the desired product as a solid orange foam (yield: 96%).

¹H-NMR (C₆D₆), characteristic signals: δ 7.5-6.8 (m, 40H), 5.24-5.12 (m, 2H), 4.52 (m, 2H), 4.25 (m, 2H), 3.01 (m, 2H), 2.19 (d, 6H), 1.60 (d, 6H). ³¹P-NMR (C₆D₆): δ+59.1 (d); −24.6 (d).

### EXAMPLE A9

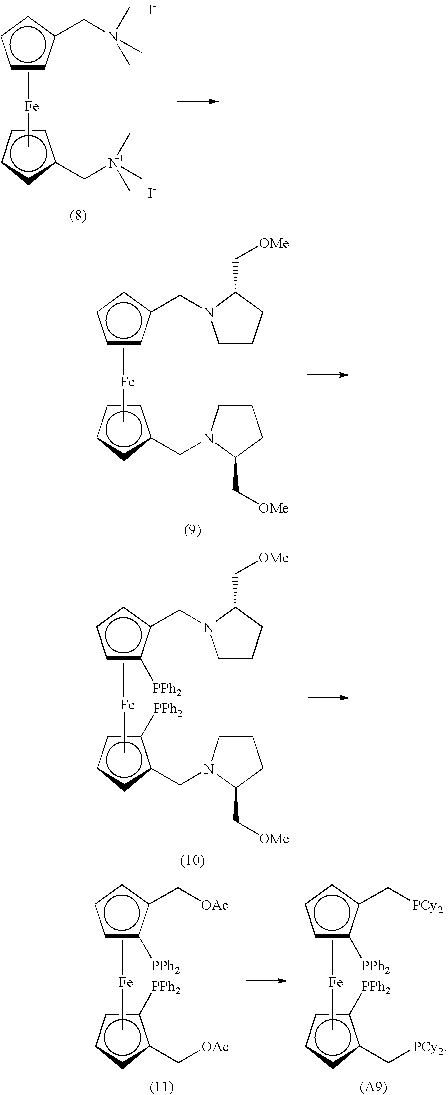 a) Preparation of Compound (8)

Compound (8) is prepared as described by C. Glidewell et al. in J. Organometal. Chem. 527 (1997), pages 259-261.

b) Preparation of Compound (9)

4.94 g (42.88 mmol) of (S)-2-(methoxymethyl)pyrrolidine are added to 5.01 g (8.57 mmol) of the compound (8) in 600 ml of dry acetonitrile and the reaction mixture is stirred at 100° C. for 72 hours. After cooling, the solvent is distilled off on a rotary evaporator. The residue is extracted with saturated aqueous NaHCO₃/methylene chloride, the organic phases are dried over sodium sulphate and evaporated on a rotary evaporator. Chromatography (silica gel 60; eluent=1 THF/2 heptane and 2% triethylamine) gives the desired product as an orange oil.

¹H-NMR (C₆D₆), characteristic signals: a 4.16 (m, 2H), 4.11 (m, 2H), 3.98 (m, 4H), 3.95-3.90 (d, 2H), 3.50-3.40 (m, 4H), 3.24-3.19 (m, 2H), 3.20 (s, 6H), 2.97 (m, 2H), 2.79 (m, 2H), 2.21 (m, 2H), 1.81-1.42 (m, 8H).

c) Preparation of Compound (10)

730 mg (1.66 mmol) of the compound (9) are dissolved in 2 ml of TBME. While stirring at −78° C., 3.18 ml (4.14 mmol) of s-BuLi (1.3 molar solution in cyclohexane) are slowly added dropwise. The reaction mixture is stirred at −78° C. for 1 hour and then at −30° C. for 4 hours. The mixture is then cooled back down to −78° C. and 988 mg (4.48 mmol) of diphenylchlorophosphine are added. After 15 minutes, the cooling is removed and the reaction mixture is stirred overnight. It is then extracted with water/TBME, the organic phase is dried over sodium sulphate and the solvent is distilled off under reduced pressure on a rotary evaporator. Chromatography (silica gel 60; eluent: firstly methylene chloride until Cl-PPh₂ has been eluted, then 1 THF/5 heptane and 1% triethylamine) gives the desired product as a yellow solid (yield: 70%).

¹H-NMR (C₆D₆), some characteristic signals: δ 7.53 (m, 4H), 7.29 (m, 4H), 7.05-6.96 (m, 12H), 4.64-4.59 (m, 2H), 4.39 (m, 2H), 4.17 (m, 2H), 3.63 (m, 2H), 3.37 (m, 2H), 3.21 (s, 6H). ³¹P-NMR (C₆D₆): δ−22.6 (s).

d) Preparation of Compound (11)

A solution of 400 mg (0.49 mmol) of the compound (10) in 5 ml of acetic anhydride is stored firstly for 1 hour at 100° C. and then overnight at 90° C. The solvent is distilled off under reduced pressure. The residue obtained comprises >90% of the desired product. The residue is extracted with water/toluene, the organic phases are collected, dried over sodium sulphate and the solvent is distilled off under reduced pressure on a rotary evaporator. Chromatography (silica gel 60; eluent=1 THF/2 heptane and 1% triethylamine) gives the desired product as a yellow oil (yield: 87%).

¹H-NMR (C₆D₆), some characteristic signals: δ 7.20 (m, 4H), 7.29 (m, 4H), 7.0-6.85 (m, 12H), 5.33-5.27 (m, 2H), 5.07 (d, 2H), 4.45 (m, 2H), 4.18 (m, 2H), 3.32 (m, 2H), 1.48 (s, 6H). ³¹P-NMR (C₆D₆): δ−23.6 (s).

e) Preparation of Compound (A9)

A solution of 33 mg (0.041 mmol) of the compound (11) and 97 microlitres (0.41 mmol) of dicyclohexylphosphine in 0.5 ml of methanol is stirred firstly for 15 hours at 90° C. and then for another 15 hours at 100° C. Chromatography of the total reaction mixture (silica gel 60; eluent=1 THF/5 heptane and 1% triethylamine) gives the desired product as an orange solid.

¹H-NMR (C₆D₆), some characteristic signals: δ 7.52 (m, 4H), 7.34 (m, 4H), 7.1-6.9 (m, 12H), 4.72 (m, 2H), 4.31 (m, 2H), 4.35 (m, 2H). ³¹P-NMR (C₆D₆): δ+0.3 (d), −23.8 (d).

### EXAMPLE A10

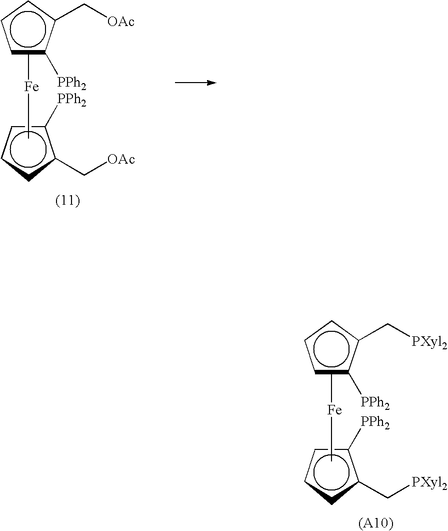

A mixture of 110 mg (0.16 mmol) of the compound (11) and 455 microlitres (0.34 mmol) of di(3,5-dimethylphenyl)phosphine (24% solution in toluene) in 1 ml of methanol are stirred overnight at 100° C. After the solvent has been distilled off under reduced pressure, chromatography of the residue (silica gel 60; eluent=1 THF/5 heptane and 1% triethylamine) gives the desired product as an orange solid.

¹H-NMR (C₆D₆), some characteristic signals: δ 7.48-6.65 (plurality of signals, 32H), 2.13 (s, 12H), 1.99 (s, 12H). ³¹P-NMR (C₆D₆): δ−13.7; −23.7.

### B) USE EXAMPLES

### EXAMPLE B1

### Hydrogenations of Unsaturated Compounds

The method of carrying out the hydrogenations and the determination of the optical yields ee is described in general terms by W. Weissensteiner et al in Organometallics 21 (2002), pages 1766-1774. The catalysts are in each case prepared in situ in the solvent by mixing of the ligand and metal complex as catalyst precursor (unless indicated otherwise=[Rh(norbornadiene)₂]BF₄). Unless indicated otherwise, the substrate concentration is 0.25 mol/l.
Hydrogenations:

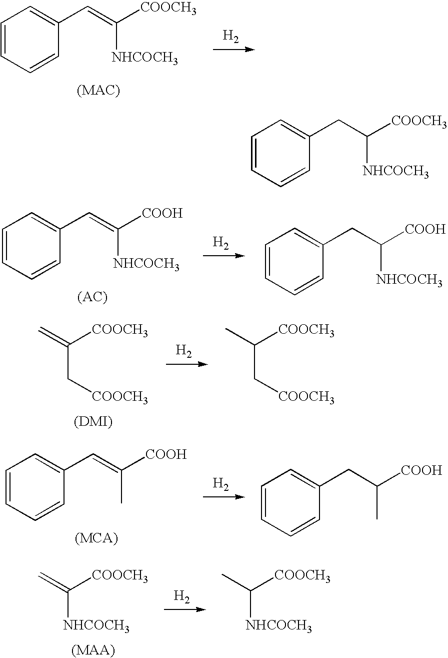

The determination of conversion and ee of MAA is carried out by means of gas chromatography using a chiral column (Chirasil-L-val).

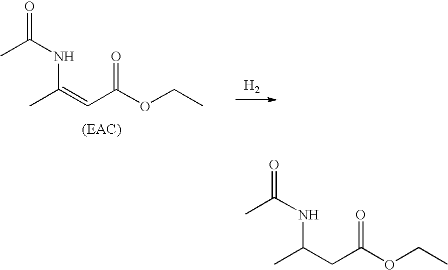

The hydrogenations of EAC are carried out in ethanol in the presence of 5% (v/v) of CF₃CH₂OH. The determination of the ee is carried out by means of gas chromatography using a chiral column [Lipodex E (30 m); 130° C. isothermal; 190 KPa H₂].

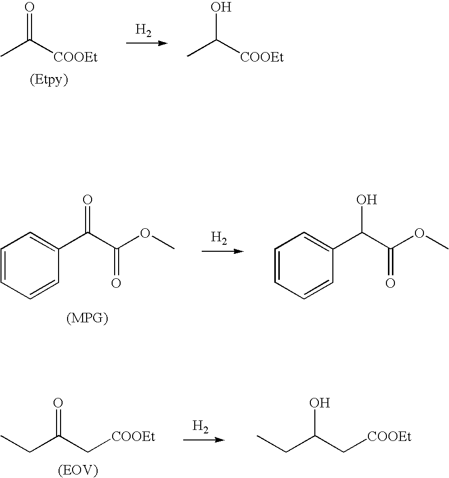

In the hydrogenation of EOV, [Rul₂(p-cumene)]₂ is used as metal complex and catalyst precursor. The determination of the ee is carried out after reaction with trifluoroacetic anhydride by means of gas chromatography using a chiral column [Lipodex E (30 m)].

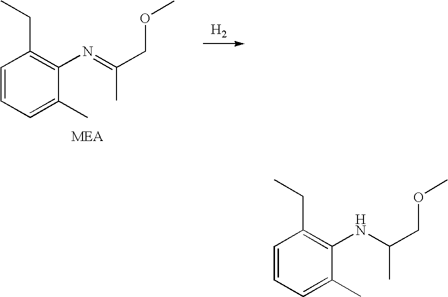

In the hydrogenation of MEA, [Ir(COD)Cl]₂ is used as metal complex and catalyst precursor. The hydrogenation is carried out in bulk using 105 g of MEA (without solvent) in the presence of 70 mg of tetrabutylammonium iodide and 10 ml of acetic acid.

Further details and the results are shown in Table 1.

TABLE 1

| | Ligand/ | Starting | | | H₂ pressure | T | Time | Conversion | ee |
|---|---|---|---|---|---|---|---|---|---|
| Ligand | Metal | material | Solvent | S/C | [10⁵ Pa] | [° C.] | [h] | [%] | [%] |
| A1 | 0.55 | MAC | MeOH | 200 | 1 | 25 | 1 | 100 | 87 |
| A4 | 0.5 | MAC | MeOH | 200 | 1 | 25 | 1 | 67 | 64 |
| A8 | 0.53 | MAC | THF | 100 | 1 | 25 | 1 | 80 | 97 |
| A8 | 0.48 | AC | THF | 100 | 3 | 25 | 1 | 100 | 99 |
| A8^{a)} | 0.48 | AC | MeOH | 100 | 3 | 25 | 1 | 100 | 53 |
| A1 | 0.55 | DMI | MeOH | 200 | 1 | 25 | 1 | 100 | 95 |
| A4 | 0.49 | DMI | MeOH | 200 | 1 | 25 | 1 | 100 | 53 |
| A6 | 0.55 | DMI | MeOH | 200 | 1 | 25 | 1 | 100 | 90 |
| A1 | 0.56 | MCA | MeOH | 200 | 1 | 25 | 1 | 17 | 26 |
| A8^{a)} | 0.53 | MCA | THF | 100 | 5 | 25 | 1 | 17 | 78 |
| A8 | 0.53 | MAA | THF | 100 | 5 | 25 | 1 | 100 | 97 |
| A8 | 0.53 | MAA | MeOH | 100 | 5 | 25 | 1 | 100 | 92 |
| A1 | 0.56 | EAC | EtOH | 200 | 1 | 25 | 1 | 52 | 55 |
| A2 | 0.48 | EAC | EtOH | 200 | 1 | 25 | 19 | 25 | 55 |
| A4 | 0.5 | EAC | EtOH | 200 | 1 | 25 | 19 | 12 | 26 |
| A4 | 1 | MPG | EtOH | 100 | 80 | 25 | 16 | 100 | 63 |
| A8 | 0.53 | MPG | EtOH | 100 | 20 | 25 | 16 | 99 | 47 |
| A8 | 0.5 | EOV | EtOH | 100 | 80 | 80 | 16 | 54 | 73 |
| A8 | 0.53 | Etpy | EtOH | 100 | 20 | 25 | 16 | 100 | 64 |
| A1 | 0.5 | MEA | | 95 000 | 80 | 50 | 20 | 24 | 63 |
| A2 | 0.5 | MEA | | 95 000 | 80 | 50 | 2 | 100 | 76 |
| A4 | 0.5 | MEA | | 95 000 | 80 | 50 | 2 | 100 | 73 |
| A7 | 0.5 | MEA | | 95 000 | 80 | 50 | 4 | 100 | 70 |

^{a)}4 mol of NEt₃/Rh, S/C = substrate to catalyst

### EXAMPLE B2

### Amination of (Hetero)Aromatics Using Palladium Complexes

A catalyst stock solution (0.035 mol of Pd(OAc)₂ and 0.0175 mmol of ligand in 1.75 ml of DME) is prepared. In a second vessel, 0.01 mmol (based on Pd. S/C=100) or 0.002 mmol (S/C=500) of the catalyst stock solution and finally 1.2 mmol of n-octylamine are added to a mixture of 1 mmol of o-chloropyridine or p-chlorotoluene and 1.4 mmol of NaOtBu in 1 ml of DME with a little dodecane as internal standard and the reaction mixture is stirred at 100° C. The reaction is monitored by means of gas chromatography (GC). The results reported in the tables are based on GC percentages by area.

| Li- | | | | | | | | |
|---|---|---|---|---|---|---|---|---|
| gand | React- | L/ | | T | Time | Starting | Product | Product |
| (L) | ion | Metal | S/C | [° C.] | [h] | material | 1 | 2 |
| A1 | 1 | 0.5 | 100 | 100 | 16 | 9 | 74 | 17 |
| A3 | 1 | 0.5 | 100 | 100 | 16 | 6 | 63 | 31 |
| A4 | 1 | 0.5 | 100 | 100 | 16 | 16 | 44 | 40 |
| A4 | 2 | 0.5 | 500 | 100 | 20 | 49 | 51 | — |

Reaction 1:

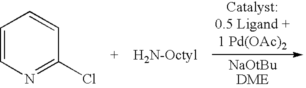

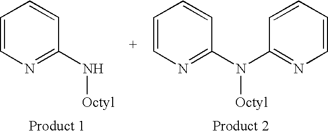

Reaction 2:

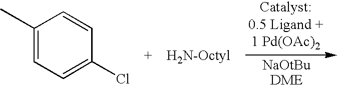

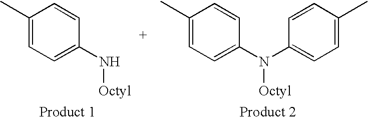

Acid amides may be used instead of amines.

1. Compounds of the formula I in the form of racemates, mixtures of diastereomers or pure diastereomers, 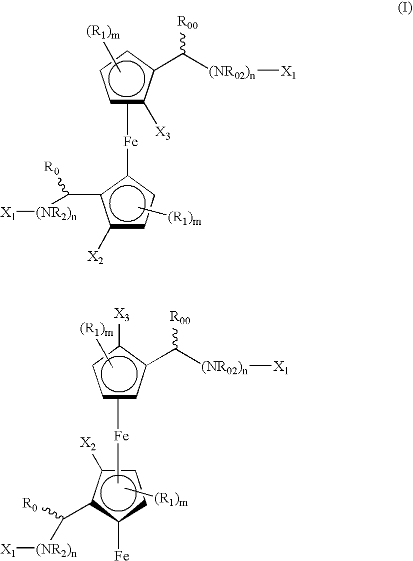
where
R₀ and R₀₀ are each, independently of one another, hydrogen, C₁-C₂₀-alkyl, C₃-C₈-cycloalkyl, C₆-C₁₄-aryl or C₃-C₁₂-heteroaryl having heteroatoms selected from the group consisting of O, S and N, which are unsubstituted or substituted by C₁-C₆-alkyl, C₁-C₆-alkoxy, C₅-C₈-cycloalkyl, C₅-C₈-cycloalkoxy, phenyl, C₁-C₆-alkylphenyl, C₁-C₆-alkoxyphenyl, C₃-C₈-heteroaryl, F or trifluoromethyl;
the radicals R₁ are each, independently of one another, a hydrogen atom, a halogen atom or a substituent bound to the cyclopentadienyl rings via a C atom, S atom, Si atom, a P(O) or P(S) group;
R₂ and R₀₂ are each, independently of one another, a hydrogen atom, C₁-C₂₀-alkyl, C₃-C₈-cycloalkyl, C₆-C₁₄-aryl or C₃-C₁₂-heteroaryl having heteroatoms selected from the group consisting of O, S and N, which are unsubstituted or substituted by C₁-C₆-alkyl, C₁-C₆-alkoxy, C₅-C₈-cycloalkyl, C₅-C₈-cycloalkoxy, phenyl, C₁-C₆-alkylphenyl, C₁-C₆-alkoxyphenyl, C₃-C₈-heteroaryl, F or trifluoromethyl;
the two indices m are each, independently of one another, 1, 2 or 3;
n is 0 or 1;
X₁ is a secondary phosphine group or a cyclic phosphonite group, and
X₂ and X₃ are each, independently of one another, a secondary phosphine group.

2. Compounds according to claim 1, characterized in that R₀ and R₀₀ are identical radicals selected from the group consisting of C₁-C₈-alkyl, C₅-C₈-cycloalkyl, phenyl and benzyl, which are unsubstituted or substituted.

3. Compounds according to claim 1, characterized in that the radicals R₁ are each hydrogen.

4. Compounds according to claim 1, characterized in that the secondary phosphine groups X₁, X₂ and X₃ and also the phosphonite group X₁ contain two identical hydrocarbon radicals.

5. Compounds according to claim 1, characterized in that the secondary phosphino groups X₁, X₂ and X₃ correspond to the formula —PR₃R₄, where R₃ and R₄ are each, independently of one another, a hydrocarbon radical having from 1 to 18 carbon atoms which is unsubstituted or substituted by halogen, C₁-C₆-alkyl, C₁-C₆-haloalkyl, C₁-C₆-alkoxy, C₁-C₆-haloalkoxy, (C₁-C₄-alkyl)₂-amino, (C₆H₅)₃Si, (C₁-C₁₂-alkyl)₃Si or —CO₂—C₁-C₆-alkyl and/or contains heteroatoms O; or X₁, X₂ and X₃ is cyclic secondary phosphino.

6. Compounds according to claim 1, characterized in that the radicals X₁ are identical and the radicals X₂ and X₃ are identical or different and X₁, X₂ and X₃ are noncyclic secondary phosphine selected from the group consisting of —P(C₁-C₆-alkyl)₂, —P(C₅-C₈-cycloalkyl)₂, —P(C₇-C₁₂-bicycloalkyl)₂, —P(o-furyl)₂, —P(C₆H₅)₂, —P[2-(C₁-C₆-alkyl)C₆H₄]₂, —P[3-(C₁-C₆-alkyl)-C₆H₄]₂, —P[4-(C₁-C₆-alkyl)C₆H₄]₂, —P[2-(C₁-C₆-alkoxy)C₆H₄]₂, —P[3-(C₁-C₆-alkoxy)C₆H₄]₂, —P[4-(C₁-C₆-alkoxy)C₆H₄]₂, —P[2-(trifluoromethyl)C₆H₄]₂, —P[3-(trifluoromethyl)C₆H₄]₂, —P[4-(trifluoromethyl)C₆H₄]₂, —P[3,5-bis(trifluoromethyl)C₆H₃]₂, —P[3,5-bis(C₁-C₆-alkyl)₂C₆H₃]₂, —P[3,5-bis-(C₁-C₆-alkoxy)₂C₆H₃]₂, and —P[3,5-bis(C₁-C₆-alkyl)₂-4-(C₁-C₆-alkoxy)C₆H₂]₂, or cyclic phosphine selected from the group consisting of 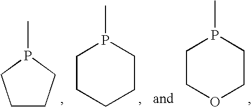
which are unsubstituted or substituted by one or more C₁-C₄-alkyl, C₁-C₄-alkoxy, C₁-C₄-alkoxy-C₁-C₂-alkyl, phenyl, benzyl, benzyloxy or C₁-C₄-alkylidenedioxyl.

7. Compounds according to claim 1, characterized in that the compounds of the formula I are preferably present as diastereomers of the formula Ia (R,S,R′S′ configuration) or Id (S,R,S′R′ configuration) or mixtures thereof or as diastereomers of the formula Ic (R,R,R′R′ configuration) or Ib (S,S,S′S′ configuration) or mixtures thereof,

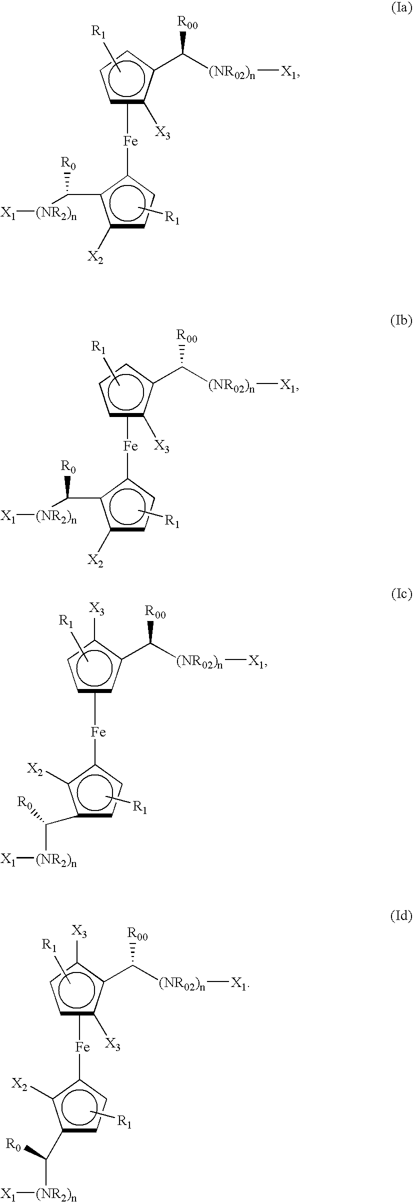

8. Metal complexes of metals selected from the group of the transition metals with a compound of the formula I as ligand, with a total of more than 1 and up to 2 equivalents of TM8 metal being bound.

9. Metal complexes according to claim 8, characterized in that the transition metals are selected from the group consisting of Fe, Co, Ni, Cu, Ag, Au, Ru, Rh, Pd, Os, Ir.

10. Use of the metal complexes according to claim 8 as homogeneous catalysts for the preparation of chiral organic compounds by asymmetric addition of hydrogen onto a carbon-carbon or carbon-heteroatom double bond in prochiral organic compounds.

11. A process for preparing chiral organic compounds by asymmetric addition of hydrogen onto a carbon-carbon or carbon-heteroatom double bond in prochiral organic compounds in the presence of a catalyst, characterized in that the addition reaction is carried out in the presence of catalytic amounts of at least one metal complex according to claim 8.
